(19) United States
(12) Patent Application Publication
(10) Pub. No.: US 2009/0003133 A1
(43) Pub. Date: Jan. 1, 2009

(54) Acoustic Telemetry

(75) Inventors: Roger Patrick Dalton, Hampshire (GB); Ian Andrew Jamieson, Fife (GB); Matthew Waters, Hampshire (GB)

Correspondence Address: MCDONNELL BOEHNEN HULBERT & BERGHOFF LLP, 300 S. WACKER DRIVE, 32ND FLOOR, CHICAGO, IL, 60606, US

(73) Assignee: QINETIQ LIMITED

(21) Appl. No.: 12/279,089

(22) PCT Filed: Mar. 20, 2007
(86) PCT No.: PCT/GB2007/000970

§ 371 Date: Aug. 12, 2008

(30) Foreign Application Priority Data
Mar. 22, 2006 (GB) 0605699.8

(51) Int. Cl. E21B 47/16; B06B 1/00

(52) U.S. Cl. 367/82; 175/40

(57) ABSTRACT

A method of transmitting data acoustically through a tubular structure, such as a drill string or production tubing in an oil or gas well, predominantly comprising a series of tubing sections (1)joined end to end by couplings (2), at least a preponderance of the tubing sections having an axial length of at least a dimension X between couplings and at least a preponderance of the couplings having an axial length of no more than a dimension x, where X is substantially greater than x. The method comprises propagating acoustic signals along the structure, between transducers (9,10) over a distance N of at least 10X, in the form of tone bursts at least predominantly comprising a selected guided wave mode (preferably the L(0, 1) mode at low frequency) with a wavelength of at least 2x, and each burst having a temporal length of substantially less than 2N/C and preferably no more than 2X/C, where C is the phase velocity of the selected mode. In this way interference problems associated with Brillouin scattering in such structures can be overcome without excessive power consumption.

The present invention relates to acoustic telemetry and more particularly to a method of transmitting data acoustically through tubular structures.

The invention is especially concerned with the acoustic transmission of data through long tubular structures of a generally periodic nature, such as drill strings or production tubing in oil or gas wells, and oil, water and gas pipelines, which are composed of many individual tubing sections joined end to end by couplings. The kind of structure over which the technique of the present invention is intended to operate will typically comprise at least ten such tubing sections but there will usually be very many more; for example it is not uncommon for deep production oil and gas wells to extend to depths of several kilometres and include production tubing strings numbering hundreds of individual sections. There is frequently a requirement for the transmission of data both downhole and uphole within a well, for example to transmit command signals from the surface for the operation of downhole motors, pumps, valves, actuators or other tools, and information signals to the surface from downhole flowmeters, strain gauges, temperature and pressure sensors, data loggers etc. Acoustic techniques where the tubular structure itself acts as a waveguide for the transmission of signals between different points along its length have been known for some time, but have hitherto not been entirely satisfactory in terms of received signal quality and power consumption, particularly when required to operate over long distances.

The invention will be described with reference to the accompanying drawings, in which:—

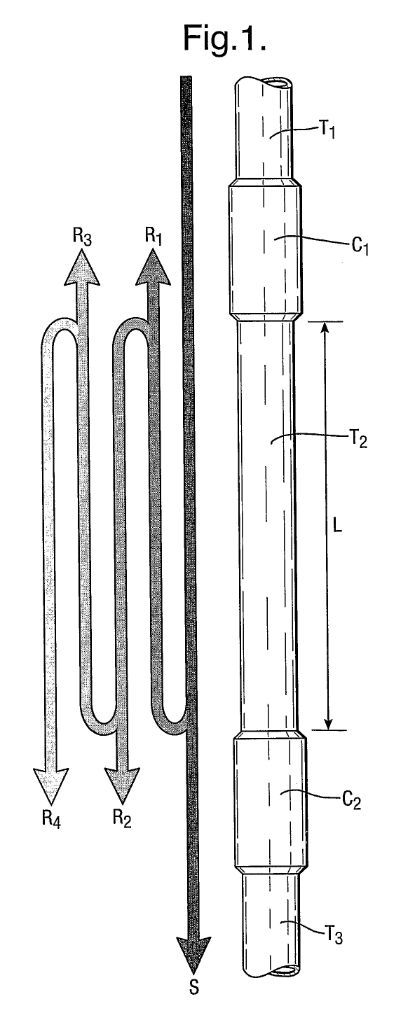

FIG. 1 is a diagram illustrating the generation of multiple acoustic signal reflections within an individual section of a periodic tubular structure;

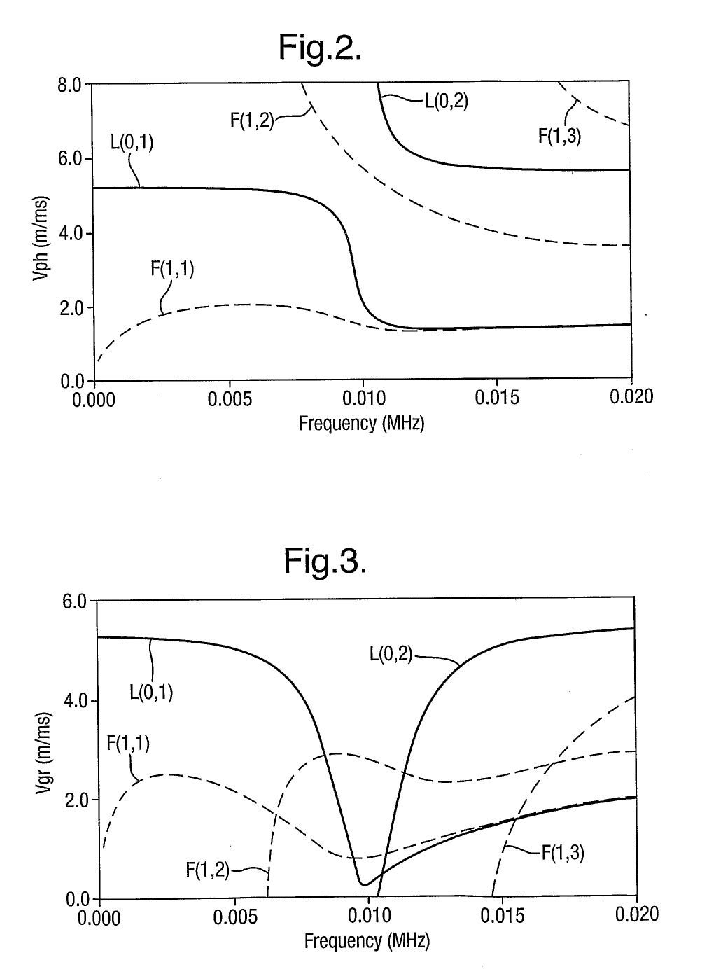

FIGS. 2 and 3 illustrate typical phase and group velocities for various acoustic modes within a tubular metal structure; and

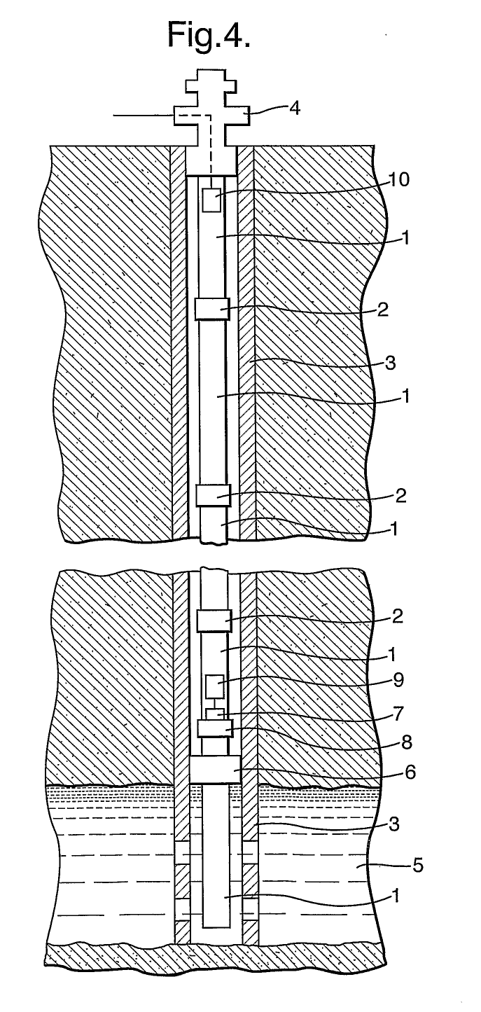

FIG. 4 illustrates schematically an acoustic telemetry system according to the invention as installed in a production oil well.

One of the problems which is encountered in acoustic telemetry of the kind indicated above is the interference effect of so-called Brillouin scattering, which is caused by signal reflections from the boundaries of the tubing sections and couplings. Consider for example FIG. 1 which shows a portion of a long tubular structure comprising many individual tubing sections T₁, T₂, T₃ . . . Tₙ joined end to end by couplings C₁, C₂ . . . Cₙ₋₁. In the case of standard steel oil production pipe the tubing sections are typically 4-23 cm in diameter and nominally 9-14 m long, screwthreaded at each end into tubular couplings typically 20-50 cm long. Now consider a signal S travelling as a guided acoustic wave through the tubular structure, and the reflections occurring within the illustrated section T₂. As the signal S travels down through the section T₂ it meets the boundary with the coupling C₂. While the transmission and reflection coefficients are determined by the mode and the boundary geometry, in general for long wavelength modes the acoustic impedances (not characteristic impedance) of the pipe section and coupling will be similar and most of the signal energy passes across this boundary unimpeded. However there is generally some degree of mismatch between the acoustic impedances and a small portion of the signal energy is reflected back towards the coupling C₁, notionally indicated in the Figure as reflection R₁, propagating as a smaller signal of length initially equal to that of the signal incident upon the boundary with C₂. At the boundary with C₁ a portion of the reflected signal R₁ will itself be reflected and propagate as a double-reflected signal R₂ back down the tubing section T₂ in the same direction as the signal S. At the boundary with C₂ a portion of signal R₂ will again be reflected as R₃ and so on with subsequent reverberations of decreasing energy passing back and forth along T₂ until the reflected power is eventually dissipated. In FIG. 1 a total of four subsequent reverberations R₁ to R₄ are shown for the purposes of illustration although in practice there will be many more. In general, mode conversion will also occur, resulting in the transmission and reflection of several modes.

Assuming that the spatial length of the signal S is at least twice the length L of the tubing section T₂ between the couplings C₁ and C₂, it will be appreciated that at least part of the second reflected signal R₂, and perhaps of the fourth reflected signal R₄ and other subsequent even-numbered reflections depending on the total length of signal S, will pass along section T₂ in the same direction and at the same time as part(s) of the signal S that are still passing through that section (i.e. part(s) of that signal that follow the leading part of length 2 L), and will consequently interfere with that signal. The wavelengths of the signals will determine the extent to which this interference is constructive or destructive. Furthermore it will be appreciated that the same scattering of the signal S will occur in each of the tubing sections T₁-Tₙ, resulting in a complex trail of reverberations following the leading edge of the signal S along the structure. The effect is of course equivalent whether the signal S is propagated in the direction indicated in FIG. 1 (i.e. in the downhole direction in the case of an oil or gas well) or in the opposite (uphole) direction. Similar scattering effects may occur within the lengths of the couplings C₁, C₂ etc, although these tend to be insignificant if the wavelength of the transmitted signal is long (at least twice the length) in comparison with the couplings.

Since wavelength is frequency dependent, the interference between the signal S and reflected signals within the tubing sections results in a series of alternating “pass” and “stop” bands together with a further series of “stop” frequencies (sometimes referred to as “fine structure” or “comb structure”) within each pass band, the number of “stop” frequencies within the fine structure of these bands being related to the total number of tubing sections. Stop frequencies will occur, for example, at frequencies where the length of a tubular section is equal to half a wavelength or multiples thereof and pass frequencies will occur at frequencies where the length of a tubular section is equal to an odd multiple of a quarter-wavelength (i.e. the frequencies lying between the half-wavelength stop frequencies).

This effect has been recognised in the art for some time. It might therefore be expected that signals could be transmitted with little attenuation along the length of such a structure simply by selecting a frequency in a pass band calculated from the nominal length of the sections from which it is composed. In most practical cases, however, the tubular sections vary in length at least to some extent, and sometimes by design. The corresponding stop and pass bands therefore overlap with each other and a clean signal cannot be propagated throughout a structure of any significant length.

Others have proposed techniques to overcome the difficulties of acoustic telemetry through structures of this kind. For example U.S. Pat. No. 5,128,901 proposes a method of acoustic telemetry through a drill string using a modulated continuous acoustical carrier wave in the pass bands of the drill string and where the data signal is preconditioned by multiplying each frequency component by exp(-ikL) where i is √-1, k is the wave number in the drill string at the frequency of each component and L is the transmission length of the structure. However this method is still likely to suffer from mode conversion and interference effects at the couplings, it is necessary to know both the pass bands and L with accuracy, and the use of a continuous carrier wave implies substantial power consumption during operation of the system. U.S. Pat. No. 6,442,105 proposes an alternative approach, for acoustic telemetry through oil well production tubing, using a broadband communications technique where transmitted signals comprise a sweep of selected frequencies over a time period, i.e. chirp signals, and which relies on at least one of the frequencies reaching the other end of the structure. This method is however wasteful of power as it is expected that a large proportion of the transmitted energy will be blocked in the course of passage through the structure and each signal must have a substantial length in order to complete the frequency sweep. U.S. Pat. No. 5,050,132 proposes a method of acoustically transmitting data signals over a drillstring which aims to avoid destructive interference caused by the signal being reflected back and forth from the ends of the drillstring, by transmitting in a passband of the drillstring and limiting the time period of each transmission to be equal to or less than the time for the data signals to travel three lengths of the drillstring. However this fails to recognise the Brillouin scattering interference effect due to signal reflections within the individual tubing sections, which cannot be overcome solely by addressing reflections from the ends of the whole structure. Furthermore the proposed technique will not even prevent interference from being caused by the signals being reflected back and forth from the ends of the entire string unless the stated time period is truncated to the time taken for the data signals to travel only twice the length of the drillstring.

It is observed in relation to the prior art techniques indicated above that, particularly in the case of data transmission in the uphole direction, a telemetry method which minimises power consumption is highly desirable as the power available downhole for operation of the system is likely to be at a premium.

With reference to the Brillouin scattering problem discussed above one factor which the prior art has failed to exploit is that, within a given tubular section, interference of the transmitted signal with its own reflection(s) only occurs when the signal is of a spatial length greater than twice the distance of the section between couplings (or in other words of a temporal length greater than twice that distance divided by the signal's speed of travel).

With the foregoing in mind, in one aspect the present invention resides in a method of transmitting data acoustically through a tubular structure predominantly comprising a series of tubing sections joined end to end by couplings, at least a preponderance of said tubing sections having an axial length of at least a dimension X between couplings and at least a preponderance of said couplings having an axial length of no more than a dimension x, where X is substantially greater than x; the method comprising propagating along the structure, from a first position thereon, acoustic signals in the form of tone bursts at least predominantly comprising a selected guided wave mode with a wavelength of at least 2x, and detecting said signals from a second position on the structure, where the distance N along the structure between said first and second positions is at least 10X, and wherein each said burst has, at least as initially propagated, a temporal length of no more than a multiple of X/C and substantially less than 2N/C, where C is the phase velocity of the selected mode. The invention also resides in apparatus for transmitting data in accordance with such method and in a structure equipped with such apparatus.

In this respect a “tone burst” will be understood to mean at least one, and preferably several, complete cycles of the selected wave, the maximum available number of cycles in each burst at a given frequency being determined by the above-defined temporal length limit.

From the foregoing discussion of the interference effects of Brillouin scattering it will be appreciated that the theoretical ideal solution in a method according to the invention is to apply a temporal length limit of 2X/C to each transmitted tone burst. If so truncated, Brillouin scattering is not actually avoided and each burst as received at the second said position will generally be followed by a trail of unwanted signals resulting from reflections and reverberations within the structure. However, limiting the burst length in this way, effectively to a length which can generally be received as a “clean” signal undistorted by the effects of the Brillouin scattering, means that optimal use can be made of power available at the point of transmission and is not unduly wasted on signal components that are poorly transmitted through the structure.

This also assumes that there is minimal dispersion of the signal in its passage through the structure so that lengthening of the signal does not occur to the extent that will lead to significant attenuation by interfering reflections within individual tubing sections. If necessary, steps can be taken to reduce the incidence of dispersive effects, such as by applying a Hanning window or other pulse shaping envelope to the transmitted tone burst to suppress the production of side bands. However this also means that in some circumstances it may actually be preferable to select an initial temporal length limit of somewhat less than 2X/C.

On the other hand, there may also be circumstances in which the benefits of the invention are still realised to a useful extent where the temporal length of the signal as transmitted is greater than the theoretical ideal, for example when there is little variation in individual pipe lengths or other geometrical conditions are such that the onset of Brillouin scattering effects and corresponding power wastage is not too severe notwithstanding a somewhat lengthened signal. Thus in other embodiments the signal length might be set at, say, 5X/C, 10X/C or up to around 20X/C. This should also place fewer constraints on the precision of the associated acoustic transducer design and enable the use of lower-cost system hardware.

Coding of data in a method according to the invention can be by the simple presence or absence of a transmitted burst during successive time periods (i.e. pulse position coding) or, since it should generally be possible to discriminate the transmitted tone bursts from following reverberations, a higher data rate method may be used, such as frequency or amplitude keying of the bursts. At the receiving end, signal correlation or other methods generally known in the art can be used to identify the correct signal. The temporal spacing between successive bursts should be chosen to allow the reverberations from the preceding burst to have decayed to an acceptable level before transmitting the next, in order to avoid interference. However, the fact that the length of each transmitted burst is limited in accordance with the invention also reduces the subsequent reverberation period as compared to known prior art methods.

In selecting the guided wave mode for a method according to the invention it is noted that there are three groups of modes that will propagate along the length of a tubular structure of the kind in question, namely flexural, longitudinal and torsional modes. For the purposes of the present invention it is preferred that the selected mode has both low surface radial displacement and high group velocity. The first of these criteria is desirable because surface radial displacement couples energy to the fluid within and/or surrounding the structure, resulting in strong damping of the transmitted signals, while the second facilitates isolation of the transmitted signals from reverberations and mode-converted signals which follow them.

There are an infinite number of modes for a structure of the kind in question, but the most suitable is believed to be the L(0,1) or first longitudinal mode, at a frequency at the lower end of its branch. The useful frequency band for this mode exists from a lower frequency limited by the length of the shortest tubular section with respect to the wavelength, up to a higher frequency limit defined by the acceptable limit of increasing dispersion governed by the inner and outer diameters of the tubular sections and the material from which they are made. FIGS. 2 and 3 illustrate phase and group velocities for various modes modelled for typical 18 cm outside diameter steel oil production pipe with an approximately 1 cm wall thickness. The dotted modes are flexural and can be seen to have lower maximum group velocities than the illustrated longitudinal L(0, 1) and L(0,2) modes over the illustrated frequency range. The first longitudinal mode can be seen to extend at a usefully high group velocity from zero frequency up to around 7.5 kHz which indicates an upper frequency limit for the telemetry system if it is to operate using this mode, although the maximum velocity occurs at a substantially lower frequency and the most preferred operating range is a compromise between velocity and allowable number of cycles in each tone burst. The L(0,1) mode at low frequency is preferred over other modes because it has minimal radial motion at the edges of the pipe wall over the lower frequency band and should offer the lowest possible attenuation through leakage into the contacting fluid.

Although the invention has been described above in relation to a pipeline with discrete coupling structures C₁ etc. for joining successive tubing sections, in other kinds of structure to which the invention is applicable the couplings need not be separate items from the tubing sections and such sections may be connected e.g. by respective male and female threaded portions at opposite ends. The couplings then comprise those lengths of adjacent sections over which they are screwed together. It may also be applicable to welded pipe sections or indeed to any long tubular structure having regular discontinuities in the acoustic path, and the term “coupling” is to be broadly interpreted accordingly.

The means for propagating and detecting the acoustic signals in a method according to the invention may comprise transducers based on any suitable design principles generally known in the art, but in view of the short signal lengths required by the invention they are preferably solid state devices such as transducers comprising stacks of piezoelectric elements, or magnetostrictive material, adapted to be clamped or permanently affixed to the respective tubing sections.

FIG. 4 illustrates a simple embodiment of an acoustic telemetry system according to the invention as installed in a production oil well. Production tubing, comprising numerous tubing sections 1 joined end to end by couplings 2, extends through the well inside an outer casing 3 from the traditional well head structure 4 down to a reservoir of product 5 where the outer casing is perforated to allow flow into the open end of the lowermost section 1, and with a packer 6 between the casing and the production tubing above the reservoir, all as is conventional. By way of example, a pressure sensor 7 and a flow control valve 8 are provided towards the lower end of the tubing string and are wired for communication with an acoustic transducer 9 mounted to the tubing. At the upper end of the tubing string another acoustic transducer 10 is mounted to the tubing and wired or otherwise adapted to communicate with a surface control station (not shown) via the well head 4. The transducers 9 and 10 communicate by series of acoustic tone bursts transmitted though the production tubing in accordance with the method of the invention, e.g. to transmit data from the sensor 7 to the surface and to transmit control signals from the surface to the valve 8. The downhole equipment 7, 8, 9 may be powered for this purpose by batteries or from the surface, but preferably by means of downhole power harvesting devices which generate electricity in response to the flow of product though the tubing string, such as the devices described in our copending International patent application no. GB2006/004777.

1. A method of transmitting data acoustically through a tubular structure predominantly comprising a series of tubing sections joined end to end by couplings, at least a preponderance of said tubing sections having an axial length of at least a dimension X between couplings and at least a preponderance of said couplings having an axial length of no more than a dimension x, where X is substantially greater than x; the method comprising propagating along the structure, from a first position thereon, acoustic signals in the form of tone bursts at least predominantly comprising a selected guided wave mode with a wavelength of at least 2x, and detecting said signals from a second position on the structure, where the distance N along the structure between said first and second positions is at least 10X, and wherein each said burst has, at least as initially propagated, a temporal length of no more than a multiple of X/C and substantially less than 2N/C, where C is the phase velocity of the selected mode.

2. A method according to claim 1 wherein said temporal length is not substantially more than about 20X/C.

3. A method according to claim 2 wherein said temporal length is not substantially more than 10X/C.

4. A method according to claim 3 wherein said temporal length is not substantially more than 5X/C.

5. A method according to claim 4 wherein said temporal length is not substantially more than 2X/C.

6. A method according to claim 5 wherein said temporal length is less than 2X/C.

7. A method according to claim 1 wherein the selected guided wave mode is the L(0,1) mode at low frequency.

8. A method according to claim 1 wherein the structure is a drill string or production tubing within an oil or gas well.

9. Apparatus for transmitting data acoustically over a distance N through a tubular structure predominantly comprising a series of tubing sections joined end to end by couplings, at least a preponderance of said tubing sections having an axial length of at least a dimension X between couplings and at least a preponderance of said couplings having an axial length of no more than a dimension x, where X is substantially greater than x and N is at least 10X; the apparatus comprising a transducer for propagating along the structure, from a first position thereon, acoustic signals in the form of tone bursts at least predominantly comprising a selected guided wave mode with a wavelength of at least 2x, each said burst having, at least as initially propagated, a temporal length of no more than a multiple of X/C and substantially less than 2N/C, where C is the phase velocity of the selected mode, and a transducer for detecting said signals from a second position on the structure spaced along the structure from the first by said distance N.

10. Apparatus according to claim 9 wherein said temporal length is not substantially more than about 20X/C.

11. Apparatus according to claim 10 wherein said temporal length is not substantially more than 10X/C.

12. Apparatus according to claim 11 wherein said temporal length is not substantially more than 5X/C.

13. Apparatus according to claim 12 wherein said temporal length is not substantially more than 2X/C.

14. Apparatus according to claim 13 wherein said temporal length is less than 2X/C.

15. Apparatus according to claim 9 wherein the selected guided wave mode is the L(0, 1) mode at low frequency.

16. A tubular structure predominantly comprising a series of tubing sections joined end to end by couplings, at least a preponderance of said tubing sections having an axial length of at least a dimension X between couplings and at least a preponderance of said couplings having an axial length of no more than a dimension x, where X is substantially greater than x, equipped with apparatus according to claim 9.

17. A structure according to claim 16 being a drill string or production tubing within an oil or gas well.

18. (canceled)
